(19) United States
(12) Patent Application Publication
(10) Pub. No.: US 2012/0326466 A1
(43) Pub. Date: Dec. 27, 2012

(54) ACTUATION OF A POWER OPERATED TAILGATE

(75) Inventor: David M. Kileen, Bloomfield Hills, MI (US)

(73) Assignee: GM GLOBAL TECHNOLOGY OPERATIONS LLC, Detroit, MI (US)

(21) Appl. No.: 13/166,846

(22) Filed: Jun. 23, 2011

(51) Int. Cl. B60J 5/10; E05F 15/04

(52) U.S. Cl. 296/146.4; 296/146.8; 49/358; 296/50; 296/56

(57) ABSTRACT

A system for controlling access into a vehicle through an opening in a rear portion of the vehicle body includes a tailgate arranged to selectively open and close to thereby respectively cover and uncover at least a portion of the access opening. The system also includes a first actuator and a second actuator, wherein each of the first and second actuators operatively connects the tailgate to the vehicle body and is configured to selectively open and close the tailgate. The system additionally includes a flexible drive system configured to operate substantially simultaneously the first and second actuators. Furthermore, the system includes a motor operatively connected to the tailgate and configured to operate the flexible drive system to thereby substantially synchronize the operation of the first and second actuators. A vehicle employing such a system is also provided.

### TECHNICAL FIELD

The invention relates to actuation of a power operated vehicle tailgate.

### BACKGROUND

Vehicles that have the capacity to transport substantial amounts of cargo have experienced consistent consumer demand. Such vehicles typically have a relatively large body opening so that objects which would not fit through the traditional door openings could be loaded into the cargo area. The cargo opening is frequently positioned in the aft-end of the vehicle body, and in many cases the closure design comprises a hinged door or tailgate for convenient access.

The tailgate may be hinged for pivotable movement along the aft-end of the subject vehicle's roof, such that the door operates as a liftgate, or at the aft-end of the vehicle's body sides. Such pivotable attachment of the tailgate to the body of the vehicle permits the tailgate to swing up and/or away for loading or unloading cargo. The tailgate may include a drive mechanism for selectively swinging the tailgate up and/or away from or toward the access opening. The drive mechanism may be actuated by a tailgate mounted device or by a remote controller to either gain or restrict access to the interior of the vehicle.

### SUMMARY

A system for controlling access into a vehicle through an opening in a rear portion of the vehicle body includes a tailgate arranged to selectively open and close to thereby respectively cover and uncover at least a portion of the access opening. The system also includes a first actuator and a second actuator, wherein each of the first and second actuators operatively connects the tailgate to the vehicle body and is configured to selectively open and close the tailgate. The system additionally includes a flexible drive system configured to operate, in a substantially simultaneous manner the first and second actuators. Furthermore, the system includes a motor operatively connected to the tailgate and configured to operate the flexible drive system to thereby substantially synchronize the operation of the first and second actuators.

The flexible drive system may include a first flexible drive element configured to operate the first actuator and a second flexible drive element configured to operate the second actuator. Each of the first and second actuators may be configured as a spindle drive.

The motor may be mounted either on the tailgate or on the vehicle body.

The tailgate may be hinged to the rear portion of the vehicle body for substantially vertical pivotable movement and may thus be configured as a liftgate. Additionally, the tailgate may be hinged to the rear portion of the vehicle body for substantially horizontal pivotable movement and may thus be configured as a swing-out door.

The operation of the motor may be regulated via at least one of a device located on the tailgate and a controller.

A vehicle employing such a system is also provided.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a rear view of a vehicle system for controlling access into the vehicle via operation of a tailgate, illustrating the tailgate configured as a liftgate which is shown in an open state; and

FIG. 2 is a rear view of an alternative embodiment of the system shown in FIG. 1, illustrating the tailgate configured as a swing-out door which is shown in an open state.

### DETAILED DESCRIPTION

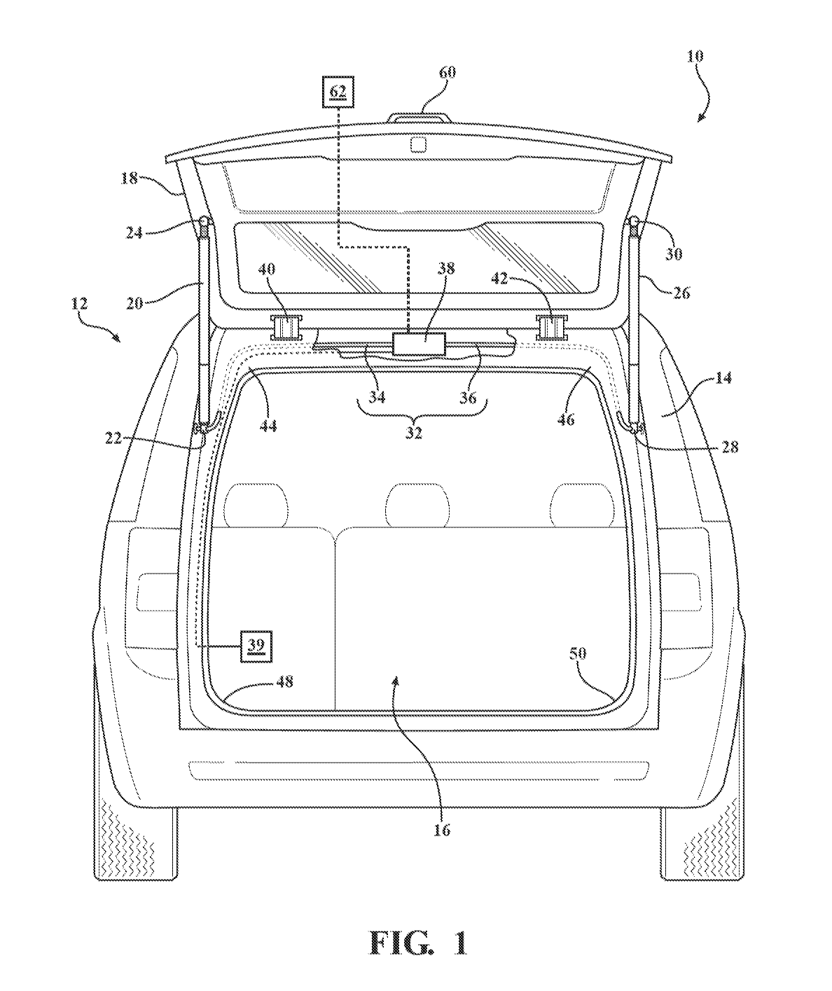

Referring to the drawings, wherein like reference numbers refer to like components, FIG. 1 shows a system 10 for controlling an access into a vehicle body 12. The vehicle body 12 encloses an interior space that is adapted to accommodate vehicle passengers and their belongings. As shown, the vehicle body 12 includes a rear portion 14 that defines an access opening 16. Besides the rear portion 14, the vehicle body 12 also includes a front portion, the existence of which, although not shown, will be appreciated by those skilled in the art.

The vehicle body 12 also includes a tailgate 18. The tailgate 18 is power operated to selectively open and close, to thereby respectively cover and uncover the access opening 16 and selectively permit and restrict access to the vehicle's interior space. The tailgate 18 is of the type that is frequently used for access to the interiors and storage compartments in vans, station wagons, and sport utility vehicles (SUVs).

The system 10 includes a first actuator 20 and a second actuator 26. The first actuator 20 and the second actuator 26 operatively connect the tailgate 18 to the vehicle body 12. The first actuator 20 is operatively connected to the vehicle body 12 via a first end 22, and to the tailgate via a second end 24. Similarly, the second actuator 26 is operatively connected to the vehicle body 12 via a first end 28, and to the tailgate via a second end 30. As shown, the first and second actuators 20, 26 are each configured as a spindle drive that utilizes a lead screw to translate radial motion into linear motion. Accordingly, the first actuator 20 and the second actuator 26 are each configured to selectively open and close the tailgate 18. In place of the described spindle drive, other devices that are capable of translating radial motion into linear motion, such as a rack and pinion, may also be employed for the first and second actuators 20, 26.

The system 10 additionally includes a flexible drive system 32 configured to operate substantially simultaneously the first and second actuators 20, 26. The flexible drive system 32 includes a first flexible drive element 34 configured to operate the first actuator 20 and a second flexible drive element 36 configured to operate the second actuator 26. The first flexible drive element 34 is operatively connected to the first end 22 of the first actuator 20, while the second flexible drive element 36 is operatively connected to the first end 28 of the second actuator 26. Each of the first and second flexible drive elements 34, 36 is characterized by a lack of moving components. The flexible drive elements 34, 36 may be produced from any suitable material, such as a flat-wrap cable conduit that is capable of withstanding torsional loads that the flexible drive elements are likely to see during operation of system 10. Although, as shown, the flexible drive system 32 operatively connects to the first and second actuators 20, 26 at their respective first ends 22 and 28, nothing precludes the flexible drive system from operating the first and second actuators by connecting to their respective second ends 24 and 30. In such a case, the internal mechanism of the first and second actuators 20, 26 would be reversed, such that the second ends 24, 30 could be driven by the flexible drive system 32.

An electric motor 38 is operatively connected to the tailgate 18 and configured to operate the flexible drive system 32 to thereby substantially synchronize the operation of the first and second actuators 20, 26. The motor 38 is electrically connected to and receives power from an energy source 39, such as a battery or a generator. Accordingly, when the motor 38 generates torque, such torque is employed to substantially simultaneously rotate the first flexible drive element 34 to drive the first end 22 of the first actuator 20 and the second flexible drive element 36 to drive the first end 28 of the second actuator 26. Hence, the torque to operate the system 10 is generated by the same, single motor 38, but is thereafter substantially simultaneously transmitted to each of the first and second actuators 20, 26 to selectively open and close the tailgate 18. Although, as shown in FIG. 1, the motor 38 is mounted on the tailgate 18, the motor may also be mounted on the rear portion 14 of the vehicle body 12.

The access opening 16 is defined by upper corners 44 and 46, and by lower corners 48 and 50. As shown in FIG. 1, the tailgate 18 is hinged to the rear portion 14 of the vehicle body 12 via hinges 40, 42 for substantially vertical pivotable movement and is configured as a liftgate. The hinges 40, 42 are positioned proximately to the upper corners 44, 46 of the access opening 16. Consequently, the hinge 40 is located between the motor 38 and the first end 22 of the first actuator 20. Additionally, the hinge 42 is located between the motor 38 and the first end 28 of the second actuator 26. The flexible nature of the drive elements 34, 36 permits the flexible drive elements to be bent or flexed in order to pass around tailgate hinges 40, 42, and around corners 44, 46 that are otherwise arranged in the path between the motor 38 and the first ends 22, 28. The flexible drive elements 34, 36 may be similarly routed around other structures that would otherwise be positioned in the path of torque transmission between the motor 38 and the first ends 22, 28. Furthermore, the flexible nature of the drive elements 34, 36 permits the motor 38 to be mounted on entirely dissimilar plane relative to the first ends 22 and 28.

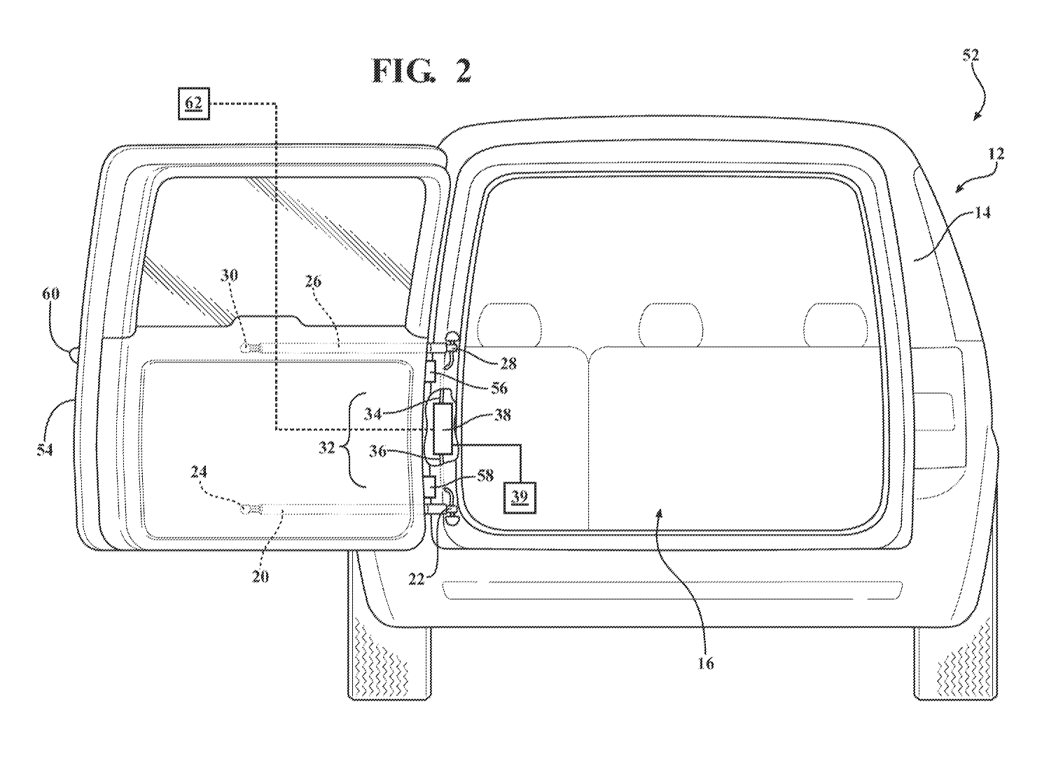

FIG. 2 illustrates a system 52 that is adapted to control an access into the vehicle body 12. The system 52 operates identically to the system 10 described above with respect to FIG. 1, except for the differences detailed below. The system 52 includes a tailgate 54 that is hinged to the rear portion 14 of the vehicle body 12 via hinges 56, 58 for substantially horizontal pivotable movement, and is thus configured as a swing-out door.

The first actuator 20 and the second actuator 26 are employed to selectively open and close the tailgate 54. The first actuator 20 and the second actuator 26 operatively connect the tailgate 54 to a vehicle body 12. The first actuator 20 is operatively connected to the vehicle body 12 via a first end 22, and to the tailgate via a second end 24. Similarly, the second actuator 26 is operatively connected to the vehicle body 12 via a first end 28, and to the tailgate 54 via a second end 30. Together, the first and second actuators 20, 26 are configured to selectively open and close the tailgate 54.

The motor 38 is operatively connected to the tailgate 54 and is configured to substantially simultaneously rotate the first flexible drive element 34 to drive the first end 22 of the first actuator 20 and the second flexible drive element 36 to drive the first end 28 of the second actuator 26. Accordingly, the motor 38 operates to selectively open and close the tailgate 54 by substantially synchronizing the operation of the first and second actuators 20, 26. Although, as shown in FIG. 2, the motor 38 is mounted on the rear portion 14 of the vehicle body 12, the motor may also be mounted on the tailgate 54. Similar to the embodiment shown in and described with respect to FIG. 1, the flexible nature of the drive elements 34, 36 permits the flexible drive elements to be bent or flexed in order to pass around tailgate hinges 56, 58 that are otherwise arranged in the path between the motor 38 and the first ends 22, 28.

The motor 38 in each of the embodiments of FIG. 1 and FIG. 2 may be actuated via a device 60, such as a lever, that is located on the tailgate. Additionally, the motor 38 may be regulated via a controller 62 that may be positioned in the interior of the vehicle, or be a remote hand-held unit employing a radio-frequency for transmitting an actuating signal.

While the best modes for carrying out the invention have been described in detail, those familiar with the art to which this invention relates will recognize various alternative designs and embodiments for practicing the invention within the scope of the appended claims.

1. A system for controlling access into a vehicle through an access opening in a rear portion of the vehicle body, the system comprising:
a tailgate arranged to selectively open and close to thereby respectively cover and uncover at least a portion of the access opening;
a first actuator and a second actuator, wherein each of the first and second actuators operatively connects the tailgate to the vehicle body and is configured to selectively open and close the tailgate;
a flexible drive system configured to operate the first and second actuators in a substantially simultaneous manner; and
a motor operatively connected to the tailgate and configured to operate the flexible drive system to thereby substantially synchronize the operation of the first and second actuators.

2. The system of claim 1, wherein the flexible drive system includes a first flexible drive element configured to operate the first actuator and a second flexible drive element configured to operate the second actuator.

3. The system of claim 1, wherein each of the first and second actuators is configured as a spindle drive.

4. The system of claim 1, wherein the motor is mounted on the tailgate.

5. The system of claim 1, wherein the motor is mounted on the vehicle body.

6. The system of claim 1, wherein the tailgate is hinged to the rear portion of the vehicle body for substantially vertical pivotable movement and is configured as a liftgate.

7. The system of claim 1, wherein the tailgate is hinged to the rear portion of the vehicle body for substantially horizontal pivotable movement and is configured as a swing-out door.

8. The system of claim 1, wherein the operation of the motor is regulated via at least one of a device located on the tailgate and a controller.

9. A vehicle comprising:
a vehicle body having a rear portion that defines an access opening;
a tailgate arranged to selectively open and close to thereby respectively cover and uncover at least a portion of the access opening; and
a system including:
a first actuator and a second actuator, wherein each of the first and second actuators operatively connects the tailgate to the vehicle body and is configured to selectively open and close the tailgate;
a flexible drive system configured to operate the first and second actuators in a substantially simultaneous manner; and
a motor operatively connected to the tailgate and configured to operate the first and second actuators in a substantially simultaneous manner.

10. The vehicle of claim 9, wherein the flexible drive system includes a first flexible drive element configured to operate the first actuator and a second flexible drive element configured to operate the second actuator.

11. The vehicle of claim 9, wherein each of the first and second actuators is configured as a spindle drive.

12. The vehicle of claim 9, wherein the motor is mounted on the tailgate.

13. The vehicle of claim 9, wherein the motor is mounted on the vehicle body.

14. The vehicle of claim 9, wherein the tailgate is hinged to the rear portion of the vehicle body for substantially vertical pivotable movement and is configured as a liftgate.

15. The vehicle of claim 9, wherein the tailgate is hinged to the rear portion of the vehicle body for substantially horizontal pivotable movement and is configured as a swing-out door.

16. The vehicle of claim 9, wherein the operation of the motor is regulated via at least one of a device located on the tailgate and a controller.

17. A system for controlling access into a vehicle through an access opening in a rear portion of the vehicle body, the system comprising:
a tailgate arranged to selectively open and close to thereby respectively cover and uncover at least a portion of the access opening;
a first spindle drive and a second spindle drive, wherein each of the first and second spindle drives operatively connects the tailgate to the vehicle body and is configured to selectively open and close the tailgate;
a flexible drive system configured to operate the first and second spindle drives in a substantially simultaneous manner; and
a motor operatively connected to the tailgate and configured to operate the flexible drive system to thereby substantially synchronize the operation of the first and second actuators;
wherein the flexible drive system includes a first flexible drive element configured to operate the first spindle drive and a second flexible drive element configured to operate the second spindle drive.
